(19) United States
(12) Patent Application Publication
(10) Pub. No.: US 2024/0330720 A1
(43) Pub. Date: Oct. 3, 2024

(54) HYBRID CLOUD-ORCHESTRATION MAP AND ANALYZER

(71) Applicant: INTERNATIONAL BUSINESS MACHINES CORPORATION, Armonk, NY (US)

(72) Inventor: Mikael Hillborg, Umeå (SE)

(21) Appl. No.: 18/129,129

(22) Filed: Mar. 31, 2023

(51) Int. Cl. G06N 5/025; G06N 5/01

(52) U.S. Cl. CPC G06N 5/025; G06N 5/01; G06F 3/04845; G06F 2203/04804

(57) ABSTRACT

A system, method and computer program product are disclosed for heuristic validations of an orchestrated cloud configuration. Operations include retrieving container configuration information of a container of a cloud cluster environment; retrieving from a knowledge base a set of rules defining how to locate and classify associations between and among elements of a container configuration; performing a heuristic analysis of the retrieved container configuration information using the set of rules from the knowledge base; identifying associations between and among elements of the container configuration information, including identifying references, objects, and connections that are missing or improper, based on the set of rules; and providing a notification to a user that missing or improper associations, objects or references have been identified.

### BACKGROUND

Aspects of the present invention relate generally to mapping and analysis of cloud cluster/container architecture, and more particularly, to a system and method that uses a command line tool to make heuristic validations of an orchestrated cloud configuration.

There are a variety of ways a cloud system architect can design and configure a cloud environment including multiple cloud servers, clusters, and containers. Several off-the-shelf environments/tools exist to assist the architect, such as Kubernetes and OpenShift. Kubernetes is an open-source container orchestration platform that automates deploying, managing, and scaling containerized applications. In other words, Kubernetes is a cluster management system that keeps workloads running and is often used for DevOps (software development and IT operations) as a means for improving and shortening the system development life cycle. OpenShift is a family of containerization software products developed by Red Hat®. OpenShift is a hybrid cloud platform as a service built around Linux® containers orchestrated and managed by Kubernetes on a foundation of Red Hat® Enterprise Linux®.

### SUMMARY

In a first aspect of the invention, there is a computer-implemented method including: retrieving, by a processor set, container configuration information of a container of a cloud cluster environment; retrieving from a knowledge base, by the processor set, a set of rules defining how to locate and classify associations between and among elements of a container configuration; performing a heuristic analysis of the retrieved container configuration information, by the processor set, using the set of rules from the knowledge base; identifying, by the processor set, associations between and among elements of the container configuration information, including identifying references, objects, and connections that are missing, improper, or potential problems, based on the set of rules; and providing, by the processor set, a notification to a user that missing, improper, or potentially problematic associations or references have been identified.

In another aspect of the invention, there is a computer program product including one or more computer readable storage media having program instructions collectively stored on the one or more computer readable storage media. The program instructions are executable to: retrieve container configuration information of a container of a cloud cluster environment; retrieve from a knowledge base a set of rules defining how to locate and classify associations between and among elements of a container configuration; perform a heuristic analysis of the retrieved container configuration information using the set of rules from the knowledge base; identify associations between and among elements of the container configuration information, including identifying references, objects, and connections that are missing, improper, or potential problems, based on the set of rules; and provide a notification to a user that missing, improper, or potentially problematic associations or references have been identified.

In another aspect of the invention, there is a system including a processor set, one or more computer readable storage media, and program instructions collectively stored on the one or more computer readable storage media. The program instructions are executable to: retrieve container configuration information of a container of a cloud cluster environment, wherein the container configuration information is retrieved from one of a the cloud cluster environment and local files; retrieve from a knowledge base a set of rules defining how to locate and classify associations between and among elements of a container configuration; perform a heuristic analysis of the retrieved container configuration information using the set of rules from the knowledge base; identify associations between and among elements of the container configuration information, including identifying references, objects, and connections that are missing, improper, or potential problems, based on the set of rules; and provide a notification to a user that missing, improper, or potentially problematic associations or references have been identified.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment, according to an embodiment of the present invention.

FIG. 2 shows a flow diagram illustrating an exemplary method for hybrid cloud-orchestration map and analyzer, in accordance with aspects of the present invention.

FIG. 3 shows a more detailed flow diagram illustrating an exemplary method for a hybrid cloud-orchestration analyzer, in accordance with aspects of the present invention.

FIG. 4 shows a flow diagram illustrating an exemplary method for analysis of cluster properties, in accordance with aspects of the present invention.

FIG. 5 shows a flow diagram illustrating an exemplary method for providing a graphical user interface mapping references in a cloud cluster configuration, in accordance with aspects of the present invention.

FIG. 6 shows a block diagram of an exemplary environment, in accordance with aspects of the present invention.

FIG. 7 shows an illustration of an exemplary GUI display, in accordance with aspects of the present invention.

FIG. 8 shows an illustration of an exemplary GUI display with a warning, in accordance with aspects of the present invention.

FIG. 9 is an exemplary screenshot of the GUI display in operation, in accordance with aspects of the present invention.

FIG. 10 is an exemplary screenshot of the GUI display in operation after an object is moved offscreen, in accordance with aspects of the present invention.

### DETAILED DESCRIPTION

Aspects of the present invention relate generally to mapping and analysis of cloud container architecture, and more particularly, to a system and method that uses a command line tool to make heuristic validations of an orchestrated cloud configuration. Even though a variety of container orchestration platforms/environments are available to assist the cloud architect in developing a cloud container environment, it is still difficult to identify inconsistencies and errors in a configured system. Missing dependencies may not be apparent during testing because the type of error may only appear very infrequently. However, if this type of error occurs during runtime, it could crash the system, scramble the data, or have other dire consequences to the cloud system.

The present disclosure describes a system and method to map and analyze the container configuration prior to, and after deployment. A system and method are described that use a command line tool to make heuristic validations of an orchestrated cloud configuration. Features, as described, may use an optional graphical user interface (GUI) which may be rendered in addition to the text output, as the cloud configuration is validated. The graphical user interface is optional and can be bypassed. In this case, the system may perform the validation by writing text to standard out, e.g., the same device that accepted the command line input. Warnings are sent, either via the standard out or the GUI, to the architect when components of the configuration are missing, duplicated, or in a format that may be incorrect, etc.

Aspects as described herein validate a cloud orchestration by analyzing its semantics using conventions and common practice, rather than doing a pure syntax analysis of the code. Once the analysis is performed, feedback is provided to the cloud engineer (architect) rather than trying to automatically verify the topology, using a command line tool. A heuristic system reports how well defined the cloud orchestration is, on three different levels (e.g., hard association, association by convention, and missing association). In an example, a hard association is an exact name match; association by convention is related to syntax rules, as well as to information corresponding to the orchestration tool regarding common associations (e.g., an expected association of a service and a route); and missing associations are connections that have not yet been deployed to the cluster configuration. The heuristic system uses a built-in knowledge base that follows certain rules to locate and classify associations and object types. In an example, the knowledge base corresponds to a specific orchestration tool, such as Kubernetes or OpenShift, and contains information about common or expected associations. The heuristic system reports accordingly to the user, as either a warning, information, or no report at all. For instance, an association by convention is related to syntax rules and also related to common practice concerning which type of objects are usually interconnected and how they are often connected. An association by convention for a “Service” in Kubernetes or OpenShift, will usually also attach a “Route” to the Service. If there is a missing Route in the configuration definition, or there is one Service object and one Route object but they have not been associated, then there is probably some error in how the objects are referenced. This might be due to a misspelling of the name. Thus, the convention of associating a Route with a Service indicates that there is a missing association in the definition. This example would then assume that since there is a Service and a Route, there is a high probability that the objects should be connected, especially since the Service does not refer to any other object and/or the Route does not refer to any other object. In other words, the cloud orchestration map and analyzer tool also tries to figure out what the configuration is trying to achieve, in addition to analyzing associations and which object types are connected.

In another example, the configuration might define a “pipeline” which reads computer source code from a repository. A Secret should be defined to gain access to that repository and if a Secret is defined, then convention dictates that a ServiceAccount is expected to be defined that corresponds with the Secret. These conventions are defined in the knowledge base. The cloud orchestration map and analyzer tool is heuristic because the architect does not necessarily have to define all of the things that have been defined in the database.

The cloud orchestration map and analyzer tool may assume that a certain type of functionality is built by analyzing the set of objects and their associations. In an example, a project might include 100 objects and each might have 5-10 associations. The knowledge base is used to see if an identical setup exists and then checks all associations. And if there is no such identical setup, the heuristic tool checks which subsets of objects in the setup most likely should be associated—for example, if there is a single Route and a single Service, then there is a high probability that they should be associated, and if they are not associated, then a warning will be issued to the architect/cloud engineer).

It will be understood that the knowledge base is specific to the cluster configuration tool used, and conventions may vary by tool and environment.

Implementations of various embodiments may provide an improvement in the technical field of DevOps of cloud, cluster, and container environments. In particular, the cloud environment is developed using one or more tools to define associations, objects, and dependencies between and among elements of the cloud environment. A very large amount of information is to be managed in a viable configuration. A configuration may include hundreds, thousands, or some hundreds of thousands of variables and elements in the definition. Some errors in design of a container architecture might not surface until runtime many months removed from deployment. These unexpected errors can have dire consequences to applications running in the deployed containers. Therefore, it is advantageous to automate a system for mapping and analyzing the configuration both prior to deployment and at runtime. Embodiments described herein improve the performance and efficiency of cloud computing by warning the system architects of possible errors and inconsistencies prior to deployment. The analysis may be executed while still designing the system to highlight elements that are yet to be deployed. Analysis can also be performed during runtime, thus enabling staged, or incremental implementation where some features are rolled out at a later time. With current design methods, these unimplemented features or “broken links” might be overlooked unless the architect has kept impeccable records of planned implementation features—which is often a failure point in design implementation. Thus, the automated mapping and analysis described herein serves to improve the field of cloud architecture design and deployment.

Implementations of the invention are necessarily rooted in computer technology. For example, the operations of mapping and analysis of the cloud environment are computer-based and cannot be performed in the human mind. It will be understood that while textual output or GUI output showing associations may appear simple, so that it is easily understood by the architect, the mapping and analysis of the cloud configuration is often so large that it cannot easily be performed by pen and paper, or by thought analysis of the architect. Modifications to existing environments may touch so many elements within an existing configuration that it would be virtually impossible to remember them all. Further, manually analyzing the equivalent of dozens or hundreds of notebooks full of data describing the configuration to identify possible errors or missing associations cannot be performed in an efficient manner without computer automation.

It should be understood that, to the extent implementations of the embodiments described herein collect, store, or employ personal information provided by, or obtained from, individuals (for example, in the design of the cloud environment customized to a person or enterprise), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

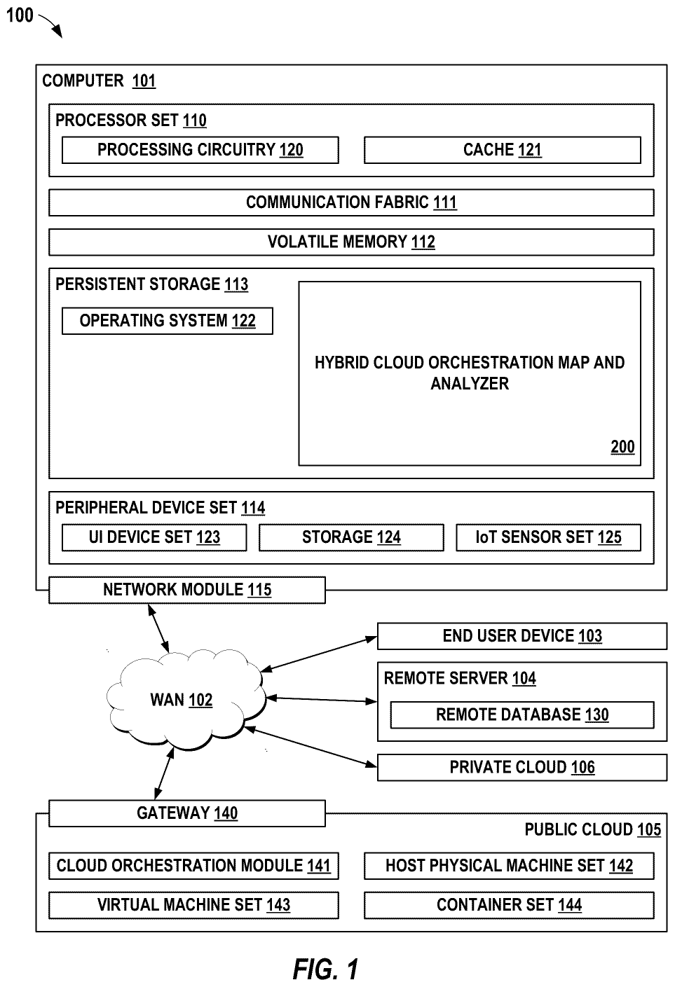

FIG. 1 depicts a computing environment, according to an embodiment of the present invention. The computing environment 100 may be used by a cloud system architect to map and analyze a defined cloud container configuration. In an embodiment, the computing environment 100 is communicatively coupled to the same environment, e.g., cluster, where the container is deployed (or is to be deployed) to facilitate access to the container configuration objects. It will be understood that computing environment 100 may generally represent a worker node in a cluster in a cloud environment or a local computing device.

Computing environment 100 contains an example of an environment for the execution of at least some of the computer code involved in performing the inventive methods, such as program code for a hybrid cloud orchestration map and analyzer module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

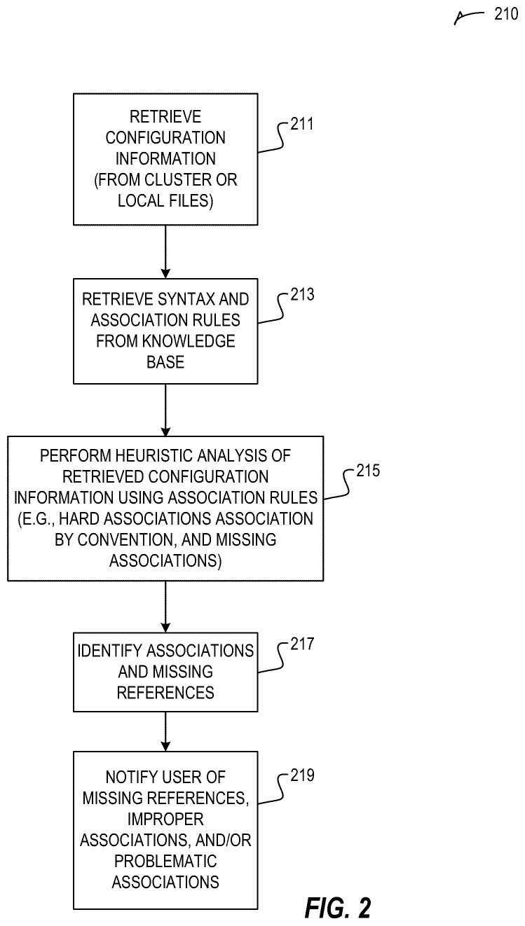

FIG. 2 shows a flow diagram illustrating an exemplary method 210 for hybrid cloud-orchestration map and analyzer, in accordance with aspects of the present invention. In an embodiment, the architect uses a command line interface command to request retrieval of configuration information from a cluster. In an embodiment, the architect logs in to the cluster, selects a project, and uses the command line to request configuration to be retrieved from the cluster, in block 211. In another embodiment, the architect retrieves local configuration files and retrieves the configuration information locally.

In an embodiment, a public knowledge base exists for the cluster environment that defines rules for creating associations and relationships using the environment tool, and enables the architect to locate and classify associations in the cluster configuration. For instance, when using Kubernetes to define a cluster environment, the command kubectl may be used to both push and retrieve configuration information. It will be understood that the Kubernetes knowledge base includes rules that define the appropriate syntax for creating configuration files using kubectl, for the Kubernetes environment. Other cluster definition environments will have their own knowledge base and rules. The syntax and association rules are retrieved from the appropriate knowledge base in block 213.

In an embodiment, the hybrid cloud orchestration map and analyzer module (200 of FIG. 1) validates the retrieved configuration (e.g., cloud orchestration) by performing heuristics, in block 215, to analyze its semantics using conventions and common practice, rather than doing a pure syntax analysis of the code. This heuristic analysis may be performed on three different levels (e.g., hard association, association by convention, and missing association). In an example, a hard association is an exact name match; an association by convention is related to syntax rules and common or expected associations, as retrieved from the knowledge base; and missing associations are connections that have not yet been deployed to the cluster configuration. For instance, an association by convention is related to syntax rules and also related to common practice concerning which type of objects are usually interconnected and how they are often connected, as discussed above. Associations and missing references are identified in block 217. In block 219, the heuristic system reports the results of the heuristic analysis to the user (e.g., architect), as either a warning, information, or no report at all.

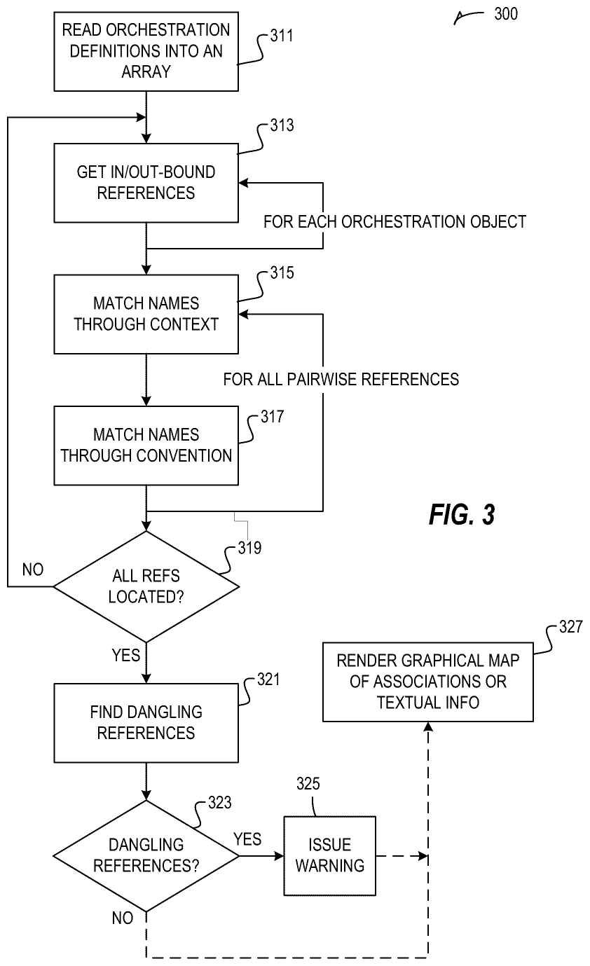

FIG. 3 shows a more detailed flow diagram illustrating an exemplary method for a hybrid cloud-orchestration map and analyzer, in accordance with aspects of the present invention. In an embodiment, the operations of method 300 may be implemented as program code as in modules of block 200 (FIG. 1). The tool or hybrid cloud-orchestration map and analyzer program code as a whole may be referred to herein as the cloud orchestration map and analyzer tool, or just “tool” for short. It will be understood that the tool may include multiple modules for various aspects of the tool. Aspects of the program module for the hybrid cloud orchestration map and analyzer may be referred to herein as an analyzer or analyzing module, and a mapper module for simplicity. A system designer, architect, DevOps, or developer (herein referred to as “architect” for simplicity) defines how the cloud system should be orchestrated by specifying properties on objects that are part of a cluster or container. A cluster is a number of physical computers which are virtualized into a number of logical “worker nodes.” These worker nodes have a number of roles depending on what is done in the cluster, and which state the cluster is in. For example, a cluster might provide a fault tolerant application which can manage a huge number of users. In this case, the cluster will perform load balancing among user tasks. Also, if a worker node crashes due to a bug in the system, the cluster ensures that a new node is started or that the one that crashed is restarted, according to a particular scheme. The scheme might be that when the load increases over a certain threshold, a new node is launched and additional incoming requests are routed to the new node. The scheme may include a number of recovery operations/tasks.

The definition of the cluster and associated containers in the cloud are defined by configuring objects and properties of the work nodes and other elements in the cloud. Objects and properties can be inserted into the cluster incrementally; they do not need to reside in the system all at once. Instead, they can be written one-by-one and added to the system. The objects and properties are typically generated in a number of local configuration files and then pushed into the system from a command console. The architect first logs in to the cluster and selects a project. The configuration of the objects and properties can also be obtained (i.e., retrieved) from the cluster by using the command console to read objects and properties, as in the retrieve operation 211 of FIG. 2. In an example, Kubernetes is used to run and maintain this type of cluster, and for retrieving the defined cluster configuration. OpenShift, an implementation of Kubernetes, may also be used. In a Kubernetes system the kubectl command line tool may be used to deploy configuration information into the cluster. The kubectl tool may also be used to retrieve the deployed configuration when logged into the cluster. When using OpenShift Container Platform, the OpenShift command line interface (CLI) tool, oc, may be used to deploy and manage cluster configurations.

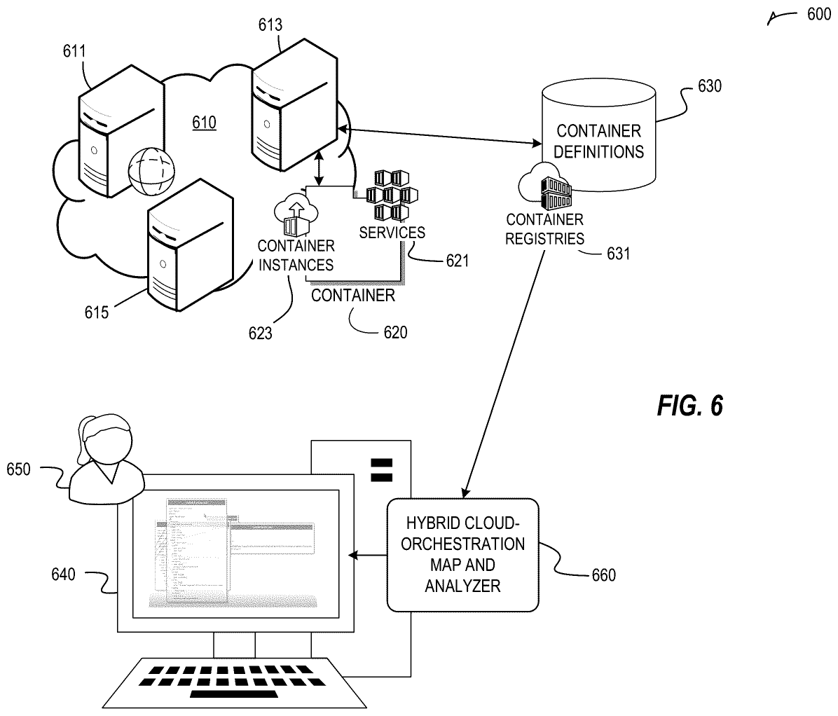

In an embodiment, the architect logs on to the cluster system so that the cluster configuration is accessible, and launches the cloud orchestration map and analyzer tool. Referring again to FIG. 3, the tool reads the orchestration definitions from the cluster configuration in block 311. In an embodiment, the architect logs on to the cluster and selects a project. Retrieving the orchestration definitions is performed by entering a command into a command line interface, as in 211 of FIG. 2. Thousands of orchestration objects may exist in the configuration which may be more than the architect wants to analyze at any given time, and if displayed in a GUI interface all at once would be visually unfeasible. Therefore, the command may include switches and parameters to select one or more categories of objects, or objects names, etc. In an example the command may include a switch such as “-includename” followed by a list of words that can be specific names which will be matched with the metadata of the objects. For example, in FIG. 6, to be more fully discussed below, the analysis is limited to a service account with the name generic-service-account. Thus, if the architect supplied that name on the command line, and perhaps in a few other names, then those objects would be used in the analysis and optional GUI display. In an embodiment, to manage large amounts of data and complex configurations the names entered can be regular expressions and then the tool will filter (e.g., a regex filter) on those and use only the objects in the current project which match the regex filter. The filtering may be to include an asterisk (*) which will match all objects in the project, or more complex like [a-z]+[0-9]* which will match against one or more lower case alphabetic characters followed by zero or more digits.

The architect may also supply a switch (for example, “-includetype”) followed by a list of object types that forces the analysis to include only a few chosen object types. In another example, the architect may exclude objects from the list, for example, if the command provides the switch “-excludetype.” For example, an architect may be in the process of debugging a load balancer in a project and may already know that the pipeline works. In this case, the architect may exclude the pipeline object with the switch “-excludetype pipeline.”

Once the selected configuration objects are retrieved, the tool stores the definitions into an array. It will be understood that an “array” can be implemented by any number of data structures, now known, or developed in the future. In an exemplary embodiment, the orchestration definitions are read into the array, where each configuration object comprises a specific array or data structure, and where each object is a sub-array of lines. Each array may be configured as a tuple of <filename, inbound_links, content>, where the content is an array of lines for the filename. It will be understood that when the configuration information is read directly from the container registries on the cluster that it is no longer in file format, but data retrieved directly from the registry. Using files is a convenient and practical way to locally create the configuration that creates objects in the cluster configuration. In industry nomenclature, the original configuration files generate objects in the registry when pushed to the cluster. In an example, multiple objects may exist in the same file and depend on the syntax of the cluster management tool (e.g., Kubernetes, OpenShift, etc.). In an example, when retrieving the configuration objects from the registry, orchestration definitions are obtained from the cluster using a command in a command line interface. Thus, the definitions may not necessarily reside on a disk or local database, but are generated by retrieving data from the cluster definition configuration, for instance using kubectl or oc commands. In an embodiment, the architect may use a local version of the system to analyze the files. In this case, the configuration information may be read directly from the original configuration files from a storage device.

A heuristic analysis, for instance 215 of FIG. 2 may be performed on the retrieved objects of the configuration information, as discussed in more detail below in conjunction with operations 311, 313, 315, 317, 319, 321, and 323. For each orchestration object, the tool gets all of the in/out-bound references, in block 313. Blocks 315 and 317 are repeated for all pairwise references. In block 315, names are matched through context, for instance, hard associations. For example, the context may associate names that occur in the context of a “taskref” or “workspace” (keywords in the configuration syntax). In block 317, names are matched through conventions. For example, if a name ends with hyphen or dash (“-”) indicating a generated name or “run” indicating a pipeline run, the naming convention indicates an association between the names. A knowledge base, as discussed in operation 213 of FIG. 2 may contain information regarding rules to locate and classify associations. For instance, a rule may exist that indicates if a “pipeline” element exists in an object that another element named “pipelinerun” should be referenced in another object. Other naming convention and their corresponding associations may exist for both prefix and suffix elements of names. In some cases, names may correspond to resource types. For instance, a task may have a parameter which has a name that indicates the resource type and a value where the value refers to a particular resource, such as an image in a repository, using a special syntax for the value. The name then indicates the resource type, for example IMAGE, and does not render any information/warning. Workspaces in a cluster definition may have any output names, and do not necessarily have to be associated. In an embodiment the mapping and analyzing modules provide an information message that the output is a placeholder for a workspace, but should be reviewed. The association and syntax rules in the knowledge base are typical rules associated with cluster and container configuration development, specific to the design tool used.

A determination is made in decision block 319 as to whether all references have been located in the cluster configuration. If all references have not been located, then processing continues at block 313, and the analysis is repeated. If all references have been located, then a search for dangling references is performed in block 321, similar to the identify associations and missing references operation 217 of FIG. 2. A dangling reference is one where the identified references are not connected, and syntax and convention indicate that something is missing. A determination is made in decision block 323 as to whether dangling references have been identified, e.g., missing references. If there are dangling references, a warning is issued to the architect in block 325, as in operation 219 of FIG. 2. The warning notifies the architect that specific references should have been associated with a property, but were not found. In an embodiment, a graphical map of associations or textual information is rendered in block 327 to be discussed more fully below in conjunction with FIG. 5.

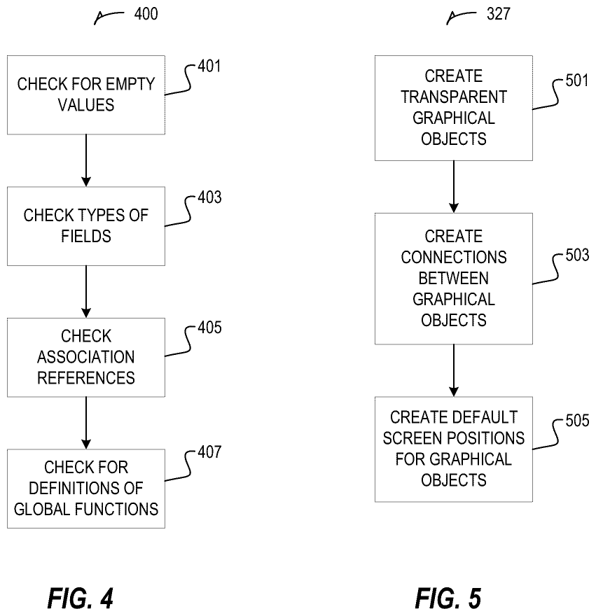

FIG. 4 shows a flow diagram illustrating an exemplary method 400 for analysis of cluster properties, in accordance with aspects of the present invention. In an embodiment, syntax analysis to identify dangling references (block 321) may include checking value fields on certain properties. For example, a field is checked to determine that values are not empty, in block 401. A field may be checked to ensure that certain values have the correct type, in block 403. For example, for a field with a SECRET type, the tool ensures that the values are encoded and do not contain plain text. In an embodiment, the SECRET field is examiner to identify that it might contain 64-bit, 128-bit, or 256-bit encryption code, or the like. If the contents of the field are too short, it may indicate that the field does not contain an encryption code, but instead contains a plain text string. In some cases, the name field is used to indicate the type (e.g., IMAGE). The analyzer module examines the associated value field to ensure that it really refers to an image in a repository, in block 405. In the cluster configuration, certain functions may reside in global scope, which means that it is a global function that was added previously, and is supposed to be used in many projects. If a certain function is referred to, but its definition is not found in the project, the tool looks it up in the global scope, in block 407. If the definition is not found in the global scope, an output is generated to the console that describes the task as not being found in either the local or global scope.

FIG. 5 shows a flow diagram 327 illustrating an exemplary method for providing a graphical user interface mapping references in a cloud cluster configuration, in accordance with aspects of the present invention. In some embodiments, the analysis provides textual output and warnings on a display console using standard out. Other embodiments enable an interactive graphical user interface (GUI) to display a map of elements referenced in the container configuration and allow a user to move graphical representations around to highlight specific configuration definitions, and see missing connections.

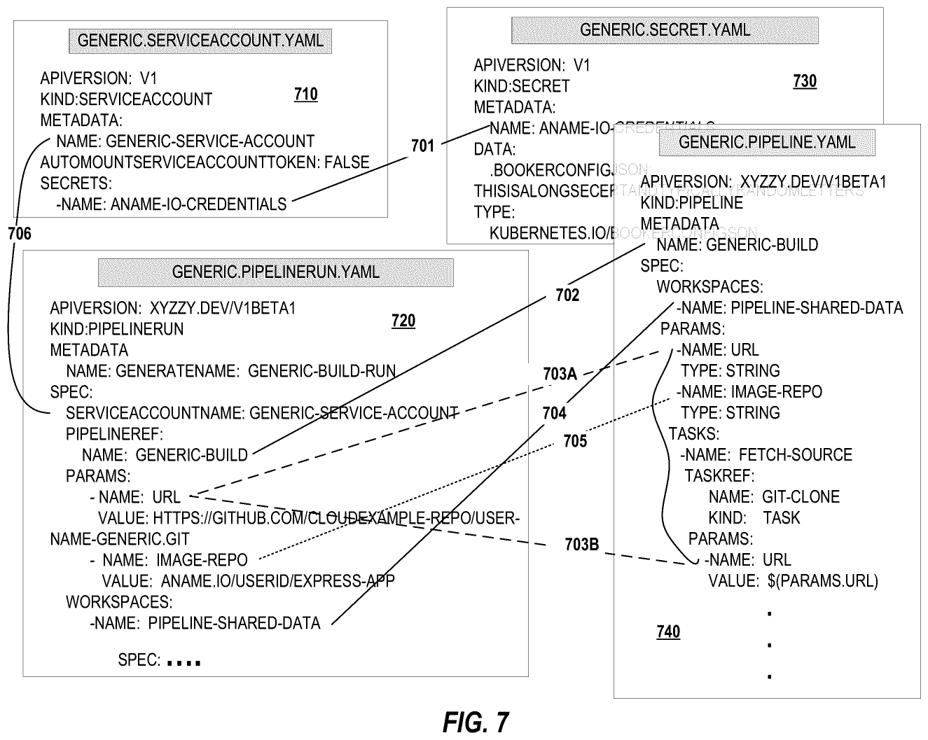

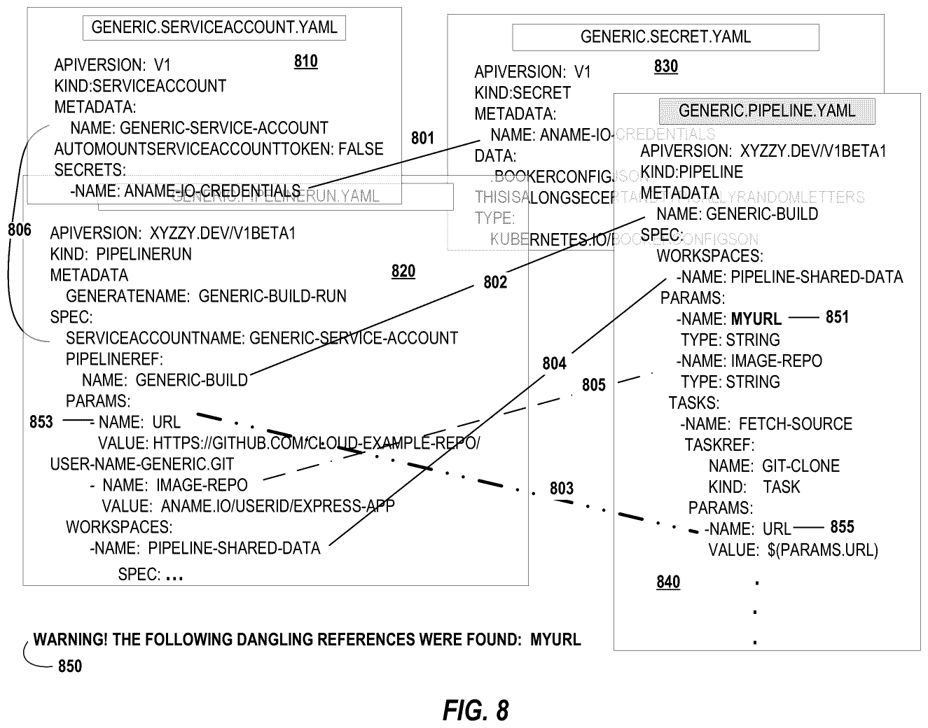

If the optional GUI is used, in block 501, the mapper module creates transparent, or semi-transparent, graphical objects corresponding to a configuration definition of an element in the container definition. In block 503, connections between the objects are displayed, where the connections start at the beginning of the line that specifies the relation. The mapper module creates pre-defined default positions on the display screen for objects corresponding to container configuration definitions, in block 505. The elements are initially displayed to the user at the default positions with connection lines to/from the line item within an object that is related to another object in the various configuration definition objects. The default positions are selected in a visually optimal layout according to the in/out-bound references, choosing to display those objects that have many relations positioned close to each other. FIGS. 7 and 8 illustrate an exemplary GUI display to be discussed more fully below.

FIG. 6 shows a block diagram of an exemplary environment 600, in accordance with aspects of the present invention. Cloud environment 610, such as WAN 102 including public cloud 105 and/or private cloud 106 of FIG. 1, is available to host clusters and containers. Cloud environment 610 may include a plurality of compute nodes 611, 613 and 615. A container 620 in the cloud 610 may include a number of services 621 and container instances 623. The container 620 may be implemented within a cluster in cloud 610, not shown. It will be understood that although only one container 620 is illustrated for simplicity, a cloud environment 610 may include more than one cluster and each cluster may include more than one container. One or more architects or DevOps engineers develop one or more cluster/container definitions 630 with a tool such as Kubernetes or OpenShift. Once deployed, the container configuration information may reside in a container registry 631, communicatively coupled to the cloud environment in a cluster. Before deployment, the configurations may reside in a local container registry or files, before launching the container/cluster in the cloud environment.

In an embodiment, a user 650 uses a computing device 640 such as a laptop/notebook computer, desktop computer, tablet, phablet or other device with input capability, such as keyboard and/or mouse, as well as a display device, where the computing device 640 has access to the local or global container registry 631. The user 650 launches a hybrid cloud-orchestration map and analyzer program or module 660 such as that described with the methods illustrated in FIGS. 2-5 and operable in program code such as in block 200 of FIG. 1.

FIG. 7 shows an illustration of an exemplary GUI display, in accordance with aspects of the present invention. In an example, a container definition is generated in YAML files. YAML is a human-readable data serialization language that is often used for writing configuration files. While it is not completely known, it is believed that YAML stands for “yet another markup language.” Another industry guess is that YAML is short for “YAML ain′t markup language”—which is a recursive acronym emphasizing that YAML is for data, not documents. It will be understood that YAML files are used for illustration. Other embodiments may retrieve other types of configuration files that define the cluster, where the type of configuration file may be now known or developed in the future. Regardless of the formats, conventions, and syntax of the configuration files, a knowledge base will exist that includes definitions of the syntax and relationship rules that can be used for mapping and analysis of the cluster configuration. The Hybrid cloud-orchestration map and analyzer module 660 (FIG. 6) retrieves the objects from the container registries 631, or local files (not shown). In this example, the YAML files define a series of objects for a cluster account, herein named generic.serviceaccount for illustrative purposes. In an embodiment, and as illustrated, the objects are rendered as transparent or semi-transparent so that the association connections can been seen on the display, even when partially obscured. When generating an interactive graphical display, the tool generates a plurality of graphical objects having a pre-defined level of transparency, where each graphical object represents a configuration object for the container configuration information. In this example, object 710 is a graphical representation of the generic.serviceaccount.yaml file. Object 720 is a graphical representation of the generic.pipelinerun.yaml file. Object 730 is a graphical representation of the generic.secret.yaml file. And object 740 is a graphical representation of the generic.pipeline.yaml file. It will be understood that these various objects are connected with references. Some references are a 1:1 match by name. Other references are based on syntax required to generate a container. For instance, a pipelinerun type of object, such as object 730, by definition, requires a pipeline object 740, or the definition will have a missing reference.

This graphical representation shows the link of references between and among objects with a connection line. For instance, object 710 includes a name “aname-io-credentials.” This indicates that a secret, or encrypted item or key, is needed for the credential. This item shows a connection line 701 to object 730 an identical item name “aname-io-credentials” in the metadata section of 730. Connection line 702 shows a reference from object 720, pipeline reference name generic-build to object 740 metadata name generic-build. Connection lines 703A-B show references from object 720 parameter name URL to two parameters in object 740 that contain a URL. Connection line 704 shows a reference from object 720 workspace element pipeline-shared-data to object 740 workspace name pipeline-shared-data. Connection line 705 shows a reference from object 720 element image-repo to object 740 element image-repo. Connection line 706 shows a reference between object 710 metadata element generic-service-account to object 720 service account name generic-service-account. It will be understood that various container definitions will result in different graphical representations, including different connection sets. In an embodiment, the user may drag an object (710, 720, 730, 740) anywhere on the display device using an input device such as a mouse. As an object is dragged to another location on the screen (or off the screen), the connection lines remain connected to the elements as shown, but may be of a different length, angle or curvature depending on the location of the original and moved objects. The connection lines may be partially hidden by moved objects. However, generating semi-transparent objects allows the lines to be seen after objects are moved, even if they seem to be slightly grayed or lighter in color when obscured by another object. The relationships remain visible to the user, however.

FIG. 8 shows an illustration of an exemplary GUI display with a warning 850, in accordance with aspects of the present invention. In an example, the objects 810, 820, 830, and 840 in FIG. 8 depict graphical objects that represent YAML files in the configuration and are similar to those objects 710, 720, 730, and 740, of FIG. 7, respectively. As discussed above, in an embodiment, and as illustrated, the objects are rendered as transparent or semi-transparent so that the association connections can been seen on the display, even when partially obscured. In this illustration, objects 810 and 830 have been moved by the user to slightly obscure objects 820 and 840, respectively, in a slightly different juxtaposition as that shown in FIG. 7. It can be seen that connection lines 801, 802, 803, 804, 805, and 806 still show the appropriate relationships, as in FIG. 7. In this example, however, one of the URLs has been misnamed as “myURL” 851 in object 840. This parameter does not match the parameter name “URL” 853 in object 820. Once the mapping and analysis has been completed, a warning 850 is displayed to the user. If URL myURL 851 was not referenced in any of the YAML configuration files, the link between the URL parameter 853 in object 820 would only need to be connected to URL parameter 855 in object 840, with connection line 803. However, the syntactical analysis shows a missing connection because the myURL parameter 851 has no counterpart in any of the YAML files for this container definition.

This missing connection might have easily been overlooked by the architect because the names are so similar. Because container definitions can be deployed incrementally, not all reference connections are required at initial deployment. Thus, this missing reference might not be uncovered until runtime—hours, days, weeks, months or years later—depending on the frequency of use for that element of the container. Thus, embodiments as described herein, allow the container architects to identify issues with the container configurations early in development or at any time during operation.

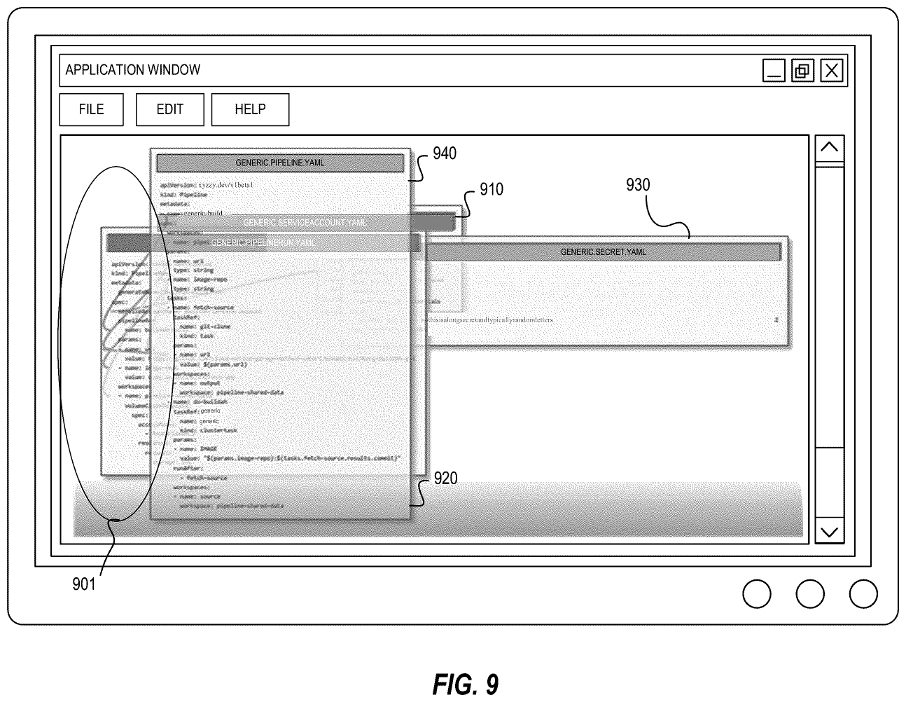

FIG. 9 is an exemplary screenshot of the GUI display in operation, in accordance with aspects of the present invention. In an example, objects 910, 920, 930, and 940 represent the same YAML files as depicted in FIG. 7 at 710, 720, 730, and 740, respectively. In this example, the user has moved the objects away from the default position to overlap and partially obscure one another. However, the connections in the YAML file that reference elements in another YAML file are still shown as connecting lines to the elements, for instance, at 901. The connection lines are automatically redrawn as curved lines or straight lines to provide the user with a display that is easy to understand graphically. A display configuration file or configurable tool setting may include rules for drawing or redrawing the connection lines based on position, transparency, number of adjacent connections, distance between reference objects, etc., to provide an optimal graphical display.

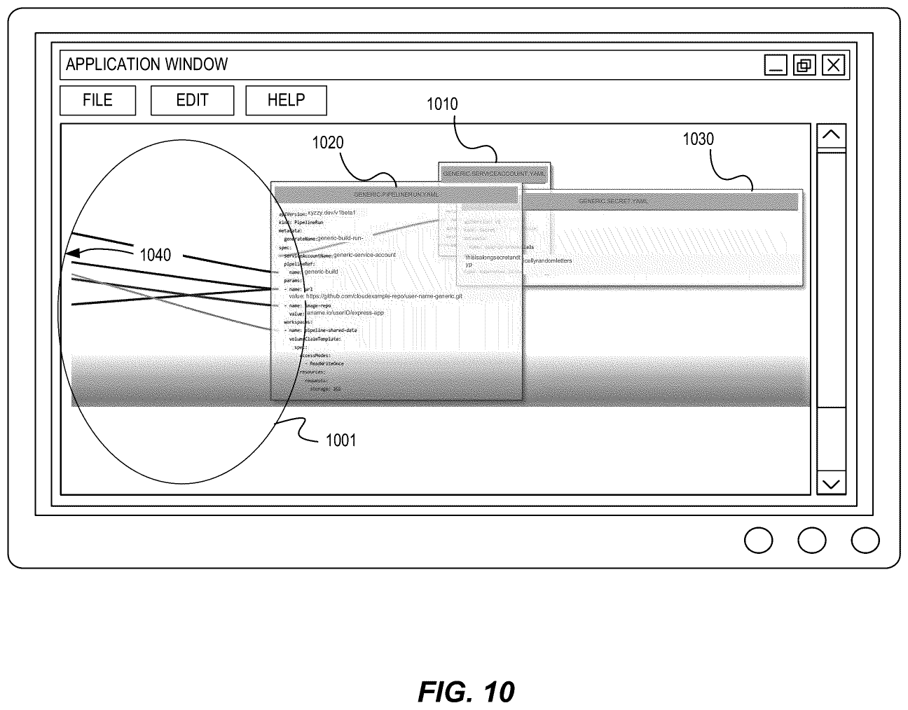

FIG. 10 is an exemplary screenshot of the GUI display in operation after an object 1040 is moved offscreen, in accordance with aspects of the present invention. In this example, objects 1010, 1020, 1030, and 1040 represent similar YAML files as depicted in FIG. 7 at 710, 720, 730, and 740, respectively. This graphical display depicts what happens when a user moves an object 1040 offscreen to the left. It can be seen that the connections lines 1001 still connect to the object 1020, and extend offscreen to 1040 even though the object cannot be seen on the display. In this way, the user can easily recognize that the references between objects exist, even when the object is moved, for instance, to more easily view other objects on the display that might have been hidden by object 1040.

In embodiments, the computing device 640 of FIG. 6 comprises the analyzer and mapping modules 210, 300, 327, 400, and 660 of FIGS. 2-6, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The computing device 640 may include additional or fewer modules than those shown in FIGS. 2-5. In embodiments, separate modules may be integrated into a single module. Additionally, or alternatively, a single module may be implemented as multiple modules. Moreover, the quantity of devices and/or networks in the environment is not limited to what is shown in FIG. 6. In practice, the environment may include additional devices and/or networks; fewer devices and/or networks; different devices and/or networks; or differently arranged devices and/or networks than illustrated in FIG. 6. In an embodiment, user 650 may access the program modules 660 either locally or via a remote compute node that is communicatively coupled to computing device 640.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method, comprising:
retrieving, by a processor set, container configuration information of a container of a cloud cluster environment;
retrieving from a knowledge base, by the processor set, a set of rules defining how to locate and classify associations between and among elements of a container configuration;
performing a heuristic analysis of the retrieved container configuration information, by the processor set, using the set of rules from the knowledge base;
identifying, by the processor set, associations between and among elements of the container configuration information, including identifying references, objects, and connections that are missing, improper or potential problems, based on the set of rules; and
providing, by the processor set, a notification to a user that missing, improper, or potentially problematic associations or references have been identified.

2. The computer implemented method as recited in claim 1, further comprising:
responsive to selection by the user of a subset of orchestration objects in a cluster project of the container configuration information, the retrieving the container configuration information of the container of a cloud cluster environment is limited to retrieving the selected subset of orchestration objects;
mapping, by the processor set, the associations between and among the elements of the container configuration information using the knowledge base to determine that properties or orchestration object are associated; and
rendering on an interactive graphical display, by the processor set, the mapping of the associations between and among the elements of the container configuration information, wherein an association between elements of the container configuration information is represented by a visible line connecting the associated elements.

3. The computer implemented method as recited in claim 2, further comprising:
generating, by the processor set, a plurality of graphical objects having a pre-defined level of transparency, wherein each graphical object represents a configuration object for the container configuration information;
generating, by the processor set, a plurality of connections between the plurality of graphical objects according to the set of rules from the knowledge base; and
rendering, by the processor set, the plurality of graphical objects and the plurality of connections on the interactive graphical display according to pre-defined default screen positioning rules.

4. The computer implemented method as recited in claim 3, further comprising:
responsive to a user moving an element of the plurality of elements to a different location of the interactive graphical display, maintaining, by the processor set, a visual connection representing the associations between and among the plurality of elements.

5. The computer implemented method as recited in claim 1, further comprising:
reading, by the processor set, container orchestration definitions from the container configuration information into a data structure;
obtaining, by the processor set, in/out-bound references from the orchestration definitions;
matching, by the processor set, names in the orchestration definitions through context;
matching, by the processor set, names in the orchestration definitions through convention rules, wherein the set of rules from the knowledge base includes the convention rules;
determining, by the processor set, whether all references in the orchestration definitions have been identified, and if not, repeating the operations of obtaining in/out-bound references and the matching through context and matching through convention operations; and
determining, by the processor set, if there are dangling references in the orchestration definitions, wherein providing a notification to the user that missing, improper, or potentially problematic associations or references have been identified includes notification of dangling references.

6. The computer implemented method as recited in claim 5, further comprising:
checking, by the processor set, for empty values in the orchestration definitions;
checking, by the processor set, field types in the orchestration definitions;
checking, by the processor set, association references in the orchestration definitions; and
checking, by the processor set, for definitions of global functions in the orchestration definitions, responsive to identifying missing function reference.

7. The computer implemented method as recited in claim 1, further comprising:
responsive to a request for analysis of a container environment by a user, accessing by the processor set, the cloud cluster environment, the cloud cluster environment including the container environment, wherein the retrieving of the container configuration information is from the cloud cluster environment.

8. The computer implemented method as recited in claim 1,
wherein the retrieving of the container configuration information is from a set of local files accessible to the processor set.

9. A computer program product comprising one or more computer readable storage media having program instructions collectively stored on the one or more computer readable storage media, the program instructions executable to:
retrieve container configuration information of a container of a cloud cluster environment;
retrieve from a knowledge base a set of rules defining how to locate and classify associations between and among elements of a container configuration;
perform a heuristic analysis of the retrieved container configuration information using the set of rules from the knowledge base;
identify associations between and among elements of the container configuration information, including identifying references, objects, and connections that are missing, improper, or potentially problematic, based on the set of rules; and
provide a notification to a user that missing, improper, or potentially problematic associations or references have been identified.

10. The computer program product as recited in claim 9, further comprising instructions executable to:
map the associations between and among the elements of the container configuration information; and
render on an interactive graphical display the map of the associations between and among the elements of the container configuration information, wherein an association between elements of the container configuration information is represented by a visible line connecting the associated elements.

11. The computer program product as recited in claim 10, further comprising instructions executable to:
generate a plurality of graphical objects having a pre-defined level of transparency, wherein each graphical object represents a configuration object for the container configuration information;
generate a plurality of connections between the plurality of graphical objects according to the set of rules from the knowledge base; and
render the plurality of graphical objects and the plurality of connections on the interactive graphical display according to pre-defined default screen positioning rules.

12. The computer program product as recited in claim 11, further comprising instructions executable to:
responsive to a user moving an element of the plurality of elements to a different location of the interactive graphical display, maintain a visual connection representing the associations between and among the plurality of elements.

13. The computer program product as recited in claim 9, further comprising instructions executable to:
read container orchestration definitions from the container configuration information into a data structure;
obtain in/out-bound references from the orchestration definitions;
match names in the orchestration definitions through context;
match names in the orchestration definitions through convention rules, wherein the set of rules from the knowledge base includes the convention rules;
determine whether all references in the orchestration definitions have been identified, and if not, repeat the operations of obtaining in/out-bound references and the matching through context and matching through convention operations; and
determine if there are dangling references in the orchestration definitions, wherein providing a notification to the user that missing, improper, or potentially problematic associations or references have been identified includes notification of dangling references.

14. The computer program product as recited in claim 13, further comprising instructions executable to:
check for empty values in the orchestration definitions;
check field types in the orchestration definitions;
check association references in the orchestration definitions; and
check for definitions of global functions in the orchestration definitions, responsive to identifying missing function reference.

15. The computer program product as recited in claim 9, further comprising instructions executable to:
responsive to a request for analysis of a container environment by a user, access the cloud cluster environment, the cloud cluster environment including the container environment, wherein the retrieving of the container configuration information is from the cloud cluster environment.

16. The computer program product as recited in claim 9,
wherein the retrieving of the container configuration information is from a set of local files.

17. A system comprising:
a processor set, one or more computer readable storage media, and program instructions collectively stored on the one or more computer readable storage media, the program instructions executable to:
retrieve container configuration information of a container of a cloud cluster environment, wherein the container configuration information is retrieved from one of the cloud cluster environment and local files;
retrieve from a knowledge base a set of rules defining how to locate and classify associations between and among elements of a container configuration;
perform a heuristic analysis of the retrieved container configuration information using the set of rules from the knowledge base;
identify associations between and among elements of the container configuration information, including identifying references, objects, and connections that are missing, improper, or potential problems, based on the set of rules; and
provide a notification to a user that missing, improper, or potentially problematic associations or references have been identified.

18. The system as recited in claim 17, further comprising program instructions executable to:
map the associations between and among the elements of the container configuration information; and
render on an interactive graphical display the map of the associations between and among the elements of the container configuration information, wherein an association between elements of the container configuration information is represented by a visible line connecting the associated elements.

19. The system as recited in claim 18, further comprising instructions executable to:
generate a plurality of graphical objects having a pre-defined level of transparency, wherein each graphical object represents a configuration object for the container configuration information;
generate a plurality of connections between the plurality of graphical objects according to the set of rules from the knowledge base; and
render the plurality of graphical objects and the plurality of connections on the interactive graphical display according to pre-defined default screen positioning rules.

20. The system as recited in claim 19, further comprising program instructions executable to:
responsive to a user moving an element of the plurality of elements to a different location of the interactive graphical display, maintain a visual connection representing the associations between and among the plurality of elements.
